(19) United States
(12) Patent Application Publication
(10) Pub. No.: US 2026/0326499 A1
(43) Pub. Date: Oct. 22, 2026

(54) Heat Exchanger and Use Thereof

(71) Applicant: MAHLE International GmbH, Stuttgart (DE)

(72) Inventors: Thomas MERTEN, Knittlingen (DE); Renata PIEKARSKA, Ostrzeszów (PL); Sascha UNGER, Ludwigsburg (DE); Uwe FÖRSTER, Erdmannhausen (DE); Piotr SWISULSKI, Ostrow Wielkopolski (PL); Jens HADLER, Stuttgart (DE); Jochen FRIZ, Welzheim (DE)

(21) Appl. No.: 19/468,660

(22) Filed: Feb. 3, 2026

(30) Foreign Application Priority Data
Feb. 5, 2025 (DE) 102025104300.0

(51) Int. Cl. B60H 1/00

(52) U.S. Cl. CPC B60H 1/00321

(57) ABSTRACT

A heat exchanger, preferably for a motor vehicle is provided. This heat exchanger has two media that exchange heat, at least one reservoir for the first medium, containing numerous slots, and numerous flat tubes connected to the reservoirs through which the first medium flows and around which the second medium flows, wherein ends of the tubes are inserted into the corresponding slots. The ends have external narrowings on the narrow sides, which are inside the reservoirs, and/or that the reservoirs have widening in their walls that are adjacent to the narrow sides of the ends inside the reservoirs. Collecting areas are formed by narrowings and/or widenings after the heat exchanger has been assembled. The reservoirs and tubes are bonded to one another, wherein the reservoirs and/or tubes have a bonding agent. The collecting areas are at least partially filled with the bonding agent after the heat exchanger has been assembled.

### CROSS-REFERENCE TO RELATED APPLICATIONS

This application claims priority from German Patent Application No. DE 102025104300.0, filed on Feb. 5, 2025, the entirety of which is hereby incorporated by reference herein.

The invention relates to a heat exchanger for a motor vehicle as set forth in the independent Numbered Paragraph. It also relates to the use thereof as set forth in the coordinate independent Numbered Paragraph.

EP 1 014 027 A1 discloses a heat exchanger with numerous flat tubes connected to at least one reservoir, through which a first medium flows and around which a second medium flows, the ends of which are inserted into slots in the reservoir. These tubes each contain numerous channels. The tubes are attached to the reservoir by a bonding agent. During assembly, some of the liquid bonding agent unfortunately enters the tubes, specifically the channels, and hardens therein. This reduces the cross section through which the medium flows through the tubes, thus impacting the performance of the heat exchanger. In particular, the outer channels in the tubes become clogged, to the point where the medium can no longer flow through them such that they no longer participate in heat exchange. Moreover, the cross section of the reservoirs is substantially larger than the wide side of the flat tubes. This increases the surface area of the inner walls of the reservoirs, which are subjected to the pressure of the medium therein. This impacts the durability of the reservoirs, and thus the heat exchanger. The bonding method can comprise brazing, and the bonding agent can be a filler metal.

The object of the present invention is to improve the durability of the heat exchanger described above, as well as its performance.

The invention preferably results in a heat exchanger for a motor vehicle. This heat exchanger can be used in a refrigerant circuit or a coolant circuit in the vehicle. The refrigerant circuit can contain at least one (first) heat exchanger, a compressor, an expansion element, and an additional (second) heat exchanger. The second heat exchanger can be downstream of the expansion element. This second heat exchanger can then be used as an evaporator. In this case, the first medium is vaporized in a second medium, and heat is transferred therefrom to the refrigerant. The largely vaporized first medium is condensed in the compressor. The first heat exchanger can be used as a condenser in which heat from the vaporized first medium is transferred to the second medium when it condensates therein.

The heat exchanger obtained with the invention contains numerous flat tubes. These tubes each have a substantially rectangular cross section in which the wide side is substantially larger than narrow side.

The reservoir and tubes are attached to one another by a bonding agent. The ends of the tubes are narrowed along their narrow sides and inserted into the reservoirs, and/or the reservoirs are widened where the ends of the tubes are inserted. This forms an area where the bonding agent can collect next to the ends of the tubes after, or even during, the assembly process for the heat exchanger obtained with the invention. When bonding the reservoirs to the tubes, any excess bonding agent collects in this area, instead of in the tubes.

This approach can be used with a reservoir subjected to the pressures of the first medium or other constraints, such that it can withstand tensile loads. Slots can be formed in this reservoir in which the ends of the tubes are inserted, subjecting the inner walls of the reservoir to the pressure of the medium.

The first medium can be a refrigerant. This first medium is preferably the dual-phase refrigerant, carbon dioxide (R744). An oil can be added to the refrigerant to lubricate the compressor in the refrigerant circuit to ensure that it functions reliably. The first medium could also be a coolant, e.g. a mixture of water and glycol. Oil can also be added to the coolant to lubricate the pumps in the coolant circuit to ensure that they function reliably.

The term, “substantially” is understood to mean a deviation of ±10° when referring to angles. When referring to surface areas or volumes, “substantially” is understood to mean a deviation of 20%. With regard to lengths, “substantially” is understood to refer to a deviation of ±2 mm. “Separation” with regard to liquids means that no, or negligibly small amounts of a medium can pass through a connection. “Thermally coupled” refers to the connection of two systems or elements through which heat is exchanged via a shared surface. The “hydraulic diameter” is a substitute operand that can be used to sufficiently determine pressure losses or flow capacity in a channel if the cross section thereof is not circular. The hydraulic diameter can be used to determine the size of a channel with an arbitrary cross section, if it were to have a circular cross section with the same length and average flow speed, as well as the same pressure losses or performance level as the original channel. “Pressure losses” refer to reductions in pressures resulting from friction in the lines or channels. Pressure losses increase exponentially over the volumetric flow of a liquid. Pressure losses correspond to energy losses. “Durability” relates to the mechanical load a reservoir or tube can withstand without failing. Cracking or permanent deformation of the reservoir or tube can result in failure thereof. “Loads” are any external forces (including torques) resulting deformation (displacement, or changes in size caused by temperature fluctuations or other constraints), acting on a component such as a reservoir. “Pressure” is a force distributed over a surface area, which may comprise the operating pressure of the first medium and local flow differences in the heat exchanger. When subjected to pressures, a component may collapse. Tensile loads pull components apart. “Rigidity” relates to a component's resistance to deformation resulting from external loads (forces or torques). Rigidity may be an aspect of the material from which the component is made, and/or its design.

A thermal profile describes the spatial differences in temperature. A uniform thermal profile is one that remains constant. A single flow path can be formed by numerous tubes in the heat exchanger. A global thermal profile is a three-dimensional overall thermal profile. Irregularities in the global thermal profile for the heat exchanger may have a significant impact on the comfort of the passengers in a vehicle.

The heat exchanger can contain two separate flow paths for fluids. The first flow path is formed by the reservoir and the tubes, and the first medium flows through the heat exchanger along this first flow path. This first flow path may be subdivided into multiple flow paths. The second medium flows through the heat exchanger along the second flow path, outside the tubes. The main flow direction of the first medium inside the heat exchanger may be at an angle to that of the second medium, such that the two paths cross, thus forming a cross flow in the heat exchanger. The performance of the heat exchanger depends on volumetric flow of the second medium, the thermal storage capacities of the two media, and the temperature differences between when the media enter and exit the heat exchanger, as well as any undesired losses. The performance of the heat exchanger depends on the starting temperatures and how the two media are guided through the heat exchanger, e.g. in the form of a cross flow. Flat tubes are less likely to become deformed than the reservoirs, but may break more easily. For this reason, the durability of the tubes is of particular relevance for the durability of the overall heat exchanger obtained with the invention.

The invention relates to a heat exchanger for a refrigerant circuit or coolant circuit, preferably in a motor vehicle. This heat exchanger preferably contains two media that exchange heat, at least one reservoir for the first medium, which has numerous slots, multiple flat tubes connected to the at least one reservoir through which the first medium flows, and around which the second medium flows, the ends of which are placed in the slots in the reservoir. These tubes are thus inserted into the slots and the at least one reservoir. They can all be inserted to the same depth. The tubes are also spaced apart and adjacent to one another, forming a block. The cross section of the at least one reservoir forms planar geometric shape. A planar geometric shape can be formed by straight and/or curved lines, or described by a distance to a point. The at least one reservoir is a hollow element with walls separating its interior from the exterior. Along at least its depth, the cross section of the reservoir can be greater than the width of the flat tubes. The slots can be surrounded by a raised collar facing outward. The inner cross section of the slots may be smaller than the outer cross section of the tubes, or the tubes may have an outer cross section that is larger than the inner cross section of the slots, such that inserting the ends of the tubes compresses them in the reservoir. This forms a crimped connection between the ends of the tubes and the reservoirs. The crimped connection can be such that the ends of the tubes and slots are only loaded to the extent that it does not result in cracks in the ends of the tubes due to their brittleness. The reservoirs and tubes are bonded together with a bonding agent. During the bonding process, the reservoirs and tubes are heated such that the bonding agent becomes fluid. The pressure of the first medium acts on the surfaces of the reservoirs. In particular, it acts on the surfaces of the reservoirs bordering the slots, and may impact the durability thereof. Furthermore, the first medium can be the refrigerant carbon dioxide (R744). Carbon dioxide can exhibit pressures that are three or four times as great as the refrigerants currently used in mass production, e.g. R1234yf or R134a. This higher pressure of the first medium also acts on the surfaces bordering the slots, thus further impacting the durability of the reservoirs. With the invention, the ends of the tubes are narrowed along the narrow sides where they are inserted into the reservoirs, and/or the walls of the reservoirs are widened where the ends of the tubes are inserted. This narrowing of the tubes or widening of the reservoir walls prevents undesired ingress of excess bonding agent in the tubes, such that they do not become clogged. Furthermore, this widening strengthens the reservoirs by stiffening them, such that they can withstand greater pressures from the first medium, or the walls can be made thinner to withstand the same pressure.

Collecting areas are formed by the narrowing and/or widening after the heat exchanger has been assembled. When bonding the tubes and reservoirs, the bonding agent becomes fluid. Excess bonding agent advantageously flows into these collecting areas. This prevents it from entering the tubes and clogging them. The bonding agent can then harden in the collecting areas and remain there. Assembly of the heat exchanger is understood to mean placing the individual components together and connecting them.

At least to some extent, the narrow sides of the tubes and the inner surfaces of the reservoirs are preferably spaced apart. This further reduces the risk of liquid bonding agent entering the tubes.

The at least one reservoir and the tubes are bonded to one another by a bonding agent. This bonding agent can be applied to part or all of the outer surfaces of the tubes. It can also be applied to part or all of the inner surfaces and/or outer surfaces of the reservoirs. The bonding agent can also be placed separately between the reservoirs and the tubes, e.g. in the form of a separate film or ring. During the bonding process, the two components are heated to the point where the bonding agent is becomes fluid.

One means of bonding the reservoir to the tubes is brazing. This is a special form of soldering. With brazing, the filler metal is an alloy with a melting point above 450 °C. Brazing joints can withstand higher thermal and mechanical loads than those to which the reservoirs and tubes subjected. The bonding agent also contains a flux. The flux results in an effective wetting of the workpiece. Furthermore, the hot surfaces of the workpieces that are being joined, as well as the liquid alloy, undergo reduction (instead of oxidation) during the brazing process. Moreover, the surface tension of the filler metal is reduced. The filler metal can be a silver alloy or brass based filler. The flux can comprise boron compounds, complex fluorides, or chlorides. The outer surfaces of the tubes and reservoirs can be plated with the filler metal for the brazing process. A filler paste, film or ring could also be placed between the reservoirs and tubes when assembling the heat exchanger. Excess filler and flux can flow into the collecting areas and harden during the brazing process. This prevents clogging of the tubes with hardened filler and/or flux. The collecting areas can be at least partially filled with hardened filler and/or flux after the heat exchanger is assembled.

An adhesive can also be used to bond the reservoirs to the tubes. The outer surfaces of the tubes and reservoirs can be coated with an adhesive for this. Excess adhesive can collect and harden in the collecting areas during the bonding process. This prevents clogging of the tubes with hardened adhesive. The collecting areas can be at least partially filled with hardened adhesive after the heat exchanger is assembled.

The collecting areas are at least partially filled with the bonding material after assembly of the heat exchanger. Hardened filler and/or flux can partially fill the collecting area in the form of a bonding agent.

The narrowing of the ends of the tubes can be stepped along the narrow sides thereof. This results in a stepped tapering of the narrow sides of the ends of the tubes. These ends can have just one step that is placed inside the walls of the reservoir. The step is formed on both narrow sides. The ends can also have two steps on the narrow sides. One of the steps can be inside the walls of the reservoir on the end of the tube. The second step can be at least partially inside the slot. This reduces the cross section of the reservoir. The steps can be produced through roller burnishing or stamping. This results in a simple and efficient production process for the heat exchanger. The one step inside the reservoir with the adjacent area of the wall thereof forms the collecting area.

The narrowings could also be formed by grooves in the narrow sides at the ends of the tubes. These grooves can be recesses on both narrow sides. The grooves can be inside the walls of the reservoir and on the end of the tube. The grooves can be formed through roller burnishing or stamping. This results in a simple and efficient production process for the heat exchanger. The grooves form the collecting areas.

The widening can also be formed by grooves on the inner wall of the reservoir where the slots are formed and connected thereto. The grooves are at substantially the same level as the slots and connected thereto. The two grooves thus form the collecting areas.

The widenings can also be formed by bulges on the narrow sides of the slots This results in collars encircling the slots facing outward. These collars can also be widened at their narrow sides to form the bulges, thus forming the collecting areas. The reservoir can be produced in an extrusion process. The collars can be formed in the same step as the slots. This results in a simple and efficient production of the heat exchanger.

The widenings can be formed by bulges in the walls of the reservoir, with the slots formed inside these bulges. The bulges can be formed along the length of the reservoir, thus enlarging the interior of the reservoir. This results in reservoirs with sections that have different cross sections along their length, and therefore different hydraulic diameters. These bulges increase the spacing between the narrow sides of the ends to the inner wall of the reservoir, thus forming the widenings and therefore the collecting areas. This also increases the durability of the reservoir in that it is stiffened by the bulges in the walls. The reservoirs can be produced in an extrusion process. The bulges can be obtained in a widening process, before forming the slots. This results in a simple and efficient production of the heat exchanger.

The reservoirs can contain a number of indentations in their walls, with the widenings adjacent to the indentations and the slots in each of the widenings. The indentations can be formed along the length of the reservoir, thus reducing the interior thereof. The reservoir therefore has sections over its length with different cross sections and different hydraulic diameters. These indentations are adjacent to the widenings that increase the spacing from the narrow sides of the ends to the inner wall of the reservoir to form the collecting areas. The indentations also increase the durability of the reservoir by increasing the stiffness thereof. The reservoir can be produced in an extrusion process. The indentations can be formed in the same step as the slots. This results in a simple and efficient production of the heat exchanger.

The widenings preferably encompass the reservoir.

The bulges can also encircle the reservoir, to obtain a uniform cross section over the entire length of the reservoir, with different outer dimensions than the other sections of the reservoir.

The indentations can encompass the reservoir as well, to obtain a uniform cross section over the entire length of the reservoir, with different outer dimensions than the other sections of the reservoir.

The slots can be substantially horizontal in relation to the length of the reservoir, and the tubes can be placed above one another. The ends of the tubes are orthogonal to the length of the reservoir. This results in a simple and efficient production of the heat exchanger.

The width of the main part of the flat tubes in the heat exchanger obtained with the invention is substantially horizontal in relation to the reservoirs, and the slots and ends can be rotated in relation thereto, with the tubes being above one another over the length of the reservoirs. The slots and ends can be rotated over a line passing through the middle of the main part. The flat tubes can be curved between the ends and their main parts. By rotating the slots and the ends, the cross section of the reservoir can be reduced in relation to the width of the heat exchanger. This reduces the pressure to the inner surface of the reservoirs by the first medium, thus increasing the durability of the reservoir and the heat exchanger.

The flat tubes can be narrowed and the reservoirs can be widened. The narrowing can be formed by a stepped indentation in the ends of the tubes along the narrow side. The widening can be formed by bulges in the walls of the reservoirs, with the slots formed within the bulges. The bulges can be formed along the length of the reservoirs, enlarging the interior thereof. The reservoirs thus have sections over their lengths with different cross sections and therefor different hydraulic diameters.

The reservoirs and tubes can contain a first metallic material, preferably an aluminum alloy.

The reservoirs are preferably integral pieces. This does not mean that the reservoirs have to be made of a single piece, but that the components thereof are not only permanently connected to one another, they are also integrally joined together such that they cannot be separated without destroying them. The reservoirs can also be produced as a single piece in an extrusion process. They can also be made of two sections that are bonded to one another, or they can be hollow elements made of sheet metal, with a seam running along their lengths. The seam can be formed by welding or brazing.

The reservoirs preferably have a substantially circular cross section. They can thus form hollow cylinders. This substantially circular cross section results in a robust reservoir. This shape can withstand the high pressures of the first medium.

The tubes are preferably placed above one another and spaced apart. The inner diameter of the reservoirs may be greater than the width of the tubes.

Corrugated fins may be placed between adjacent tubes. This increases the surface area available for heat exchange between the two media, thus improving the performance of the heat exchanger obtained with the invention. By corrugating the fins, the surface area can be increased. The second medium can flow around these fins and the tubes.

The cross section of the reservoir is preferably larger than the width of the tubes or the block formed by the tubes. This provides for a simple and efficient production of the heat exchanger.

The tubes contain numerous chambers. A chamber is understood to be a channel. Such a tube is referred to as a multiport tube and is extremely durable, requires little space, and exhibits little pressure loss. The chambers increase the surface area of the tubes available for heat exchange between the two media. The first medium flows separately through each chamber in the tubes. Each of the chambers has a cross section that is a planar geometric shape. A planar geometric shape can be composed of straight and/or curved lines, or described by a distance to a point. The chamber ideally have a rectangular cross section. The spacing between the chambers may be the same or differ along the width of the tube. The chambers are preferably formed in a row along the width of the tube.

The heat exchanger can also have a second reservoir for separating the gaseous and liquid phases of the first medium, preferably a refrigerant, and or for collecting and storing the first medium. This second reservoir can be connected to the first reservoir. The second reservoir can contain a drying agent for removing moisture from the first medium.

The reservoirs can have brackets for securing the heat exchanger in place.

The invention stipulates that a refrigerant or coolant circuit has at least one heat exchanger of the type obtained with the invention.

This heat exchanger can be used in a refrigerant circuit for a motor vehicle. A dual-phase refrigerant forming a first medium flows through this refrigerant circuit. A dual-phase refrigerant has a liquid and gaseous phase, and is preferably carbon dioxide (R744). The second medium can be air from the exterior of the vehicle. The refrigerant circuit obtained with the invention can contain at least one (first) heat exchanger obtained with the invention, a compressor, an expansion element, and an additional (second) heat exchanger. The second heat exchanger can be downstream of the expansion element. In this case, the second heat exchanger can form an evaporator. The refrigerant (first medium) is then vaporized in a second medium (coolant) and heat is transferred from the second medium to the refrigerant. The largely vaporized refrigerant (first medium) is condensed in the compressor. The first heat exchanger can be operated as a condenser in which heat from the hot vaporized refrigerant (first medium) is transferred to the air (second medium) the condensation of the refrigerant (first medium) in the air (second medium). The refrigerant flows through the tubes and the air flows around them. The liquid refrigerant (first medium) is depressurized in the expansion element and flows back to the first heat exchanger. The carbon dioxide can be pressurized three to four times as much as refrigerants currently used in mass production. The inner walls of the reservoirs and the tubes are subjected to the pressure of the refrigerant. By placing the collecting areas for the bonding agent next to the openings of the tubes, an undesired ingress thereof into the tubes is prevented, or at least reduced, such that the performance of the heat exchanger is not impacted by clogging of the tubes. The cross section of the reservoirs can also be reduced by the collecting area, strengthening the reservoir by reducing the size of the inner wall subjected to pressure, because the distance from the narrow sides of the tubes to the inner wall of the reservoir can be at least partially reduced.

The heat exchanger obtained with the invention can also be used in a coolant circuit for a motor vehicle. This coolant circuit can contain a heat source, a coolant, a heat exchanger obtained with the invention, a pump, and an expansion element. The motor vehicle can have and at least partially electric drive. With vehicles that have an at least partially electric drive, the battery and the electric motor need to be kept at a constant temperature to obtain the longest possible service lives thereof, and ensure their maximum performance levels. The heat source is formed by the electric motor or the battery, and it is necessary to discharge the heat therefrom as continuously as possible. The coolant can be carbon dioxide (R744) and the second medium can be air from the exterior of the vehicle. The coolant can be conveyed through the coolant circuit by the pump. The pump generates pressure that conveys the coolant from the heat source to the heat exchanger and back. The expansion element regulates the pressure and the temperature of the coolant circulating through the coolant circuit obtained with the invention. The expansion element can be an expansion valve. An expansion valve lowers the pressure in the medium flowing through it by constricting the cross section through which it flows locally, thus increasing or expanding the volume. The expansion valve can be regulated or unregulated. The expansion element can also be an expansion tube. The expansion tube can be formed by a nozzle or regulating element. The carbon dioxide (first medium) flows through the reservoir and the tubes, and the air (second medium) flows around the tubes, such that heat is transferred from the carbon dioxide to the air. The carbon dioxide can be pressurized three to four times as much as coolant currently used in mass production. It may also be necessary to increase the volumetric flow of the carbon dioxide to be able to discharge more heat. This increases the pressure of the carbon dioxide. By placing the collecting areas for the bonding agent next to the openings in the tubes, an undesired ingress thereof into the tubes is prevented, or at least reduced, such that the performance of the heat exchanger is not reduced by clogging of the tubes. The cross section of the reservoirs can also be reduced by the collecting area, strengthening the reservoir by reducing the size of the inner wall subjected to pressure, because the distance from the narrow sides of the tubes to the inner wall of the reservoir can be at least partially reduced.

Further details and advantages of the present invention can be derived from the following descriptions of exemplary embodiments in reference to the drawings. Therein, schematically:

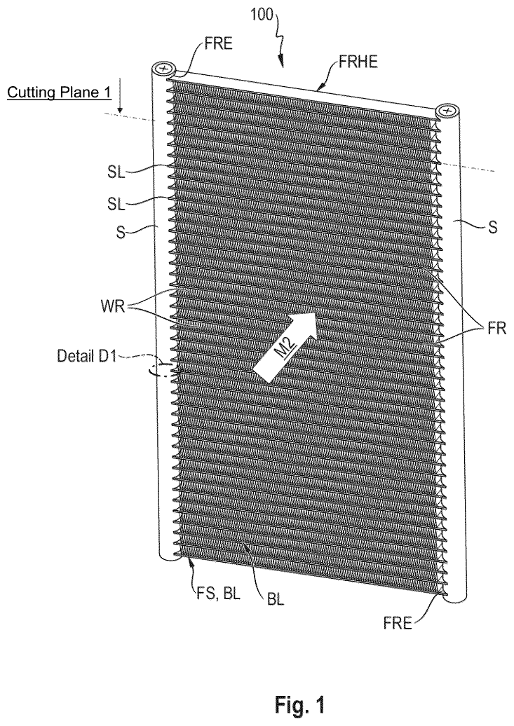

FIG. 1 shows a heat exchanger from above;

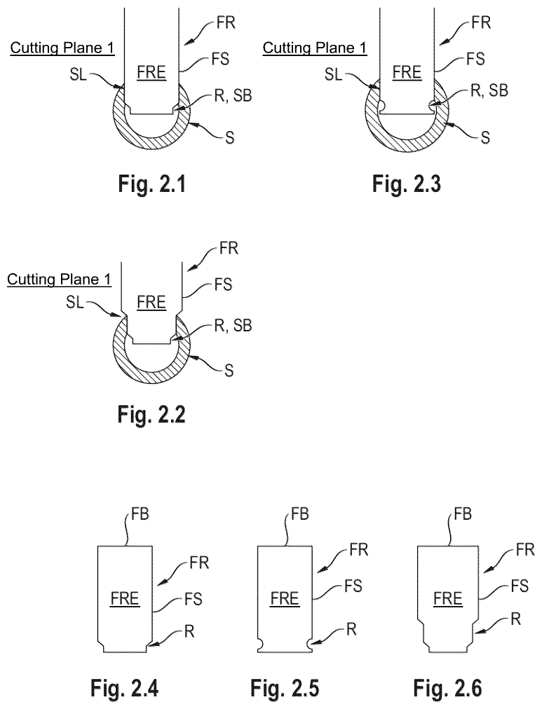

FIGS. 2.1, 2.2, 2.3 each show sectional views cut along the first cutting plane 1 through the reservoir, with an end inserted into the slot, according to a first embodiment, in which the tubes are narrowed;

FIGS. 2.4, 2.5, 2.6 show sectional views of three different embodiments of a narrowed end of a tube;

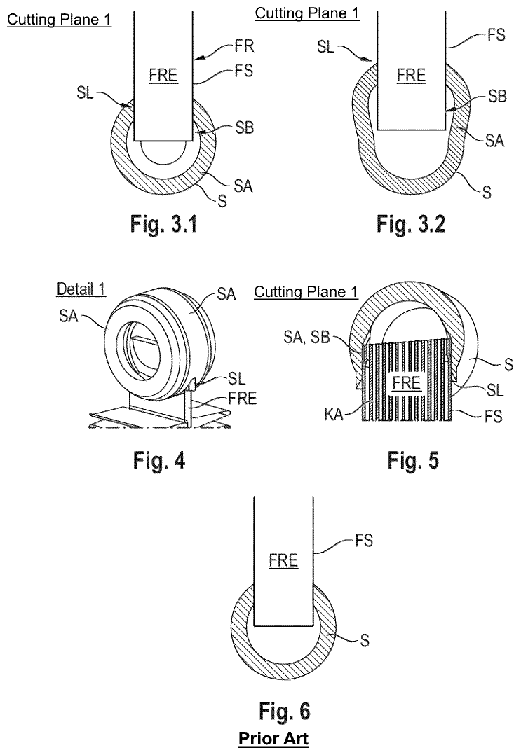

FIGS. 3.1, 3.2 each show sectional views cut along the first cutting plane 1 through the reservoir, with an end inserted in the slot according to a first embodiment, in which the reservoir has bulges;

FIG. 4 shows the first detail of the reservoir with an end inserted in the slot, which has bulges of a different embodiment;

FIG. 5 shows a sectional view of the reservoir cut along the first cutting plane 1, which has bulges with an end inserted in the slot along the section 1, according to another embodiment; and

FIG. 6 shows the prior art, in a sectional view of an existing reservoir with an end inserted in the slot.

FIG. 1 shows an assembled heat exchanger 100 from above. This heat exchanger 100 can be used in a refrigerant circuit or coolant circuit for a motor vehicle. The heat exchanger 100 contains two reservoirs S with numerous flat tubes FR placed above one another between them. The tubes FR each have a substantially rectangular cross section with a narrow side FS and a wide side FB, which are substantially orthogonal to the two reservoirs S. Each tube has a main section FRH and two ends FRE, which have the same orientation as the main section FRH. The two reservoirs S have a substantially circular cross section, forming hollow cylinders that are closed at the top and bottom by caps. The reservoirs S are circular walled cylinders through which the first medium (not shown) flows. This first medium flows through the tubes FR, and the second medium M2 flows around them such that the two media can exchange heat. The first medium can be a refrigerant such as carbon dioxide (R744), and the second medium M2 can be air from outside the heat exchanger 100. The first medium is distributed to the tubes FR by the two reservoirs S, and then returned thereto. The reservoirs S can be connected to brackets for securing the heat exchanger 100 in place, and/or to other reservoirs or batteries (not shown). There are corrugated fins WR between the tubes FR for increasing the surface area available for heat exchange between the media. The ends FRE are inserted in elongated slots SL in the reservoirs S, thus connecting the tubes FR and the two reservoirs S to one another. The ends FRE extend partially into the reservoirs S. The slots S have substantially the same orientation as the tubes FR and are substantially orthogonal to the two reservoirs S. The inner cross section of the slots S is smaller than the outer cross section of the tubes FR, such that they are crimped therein when they are inserted during the assembly process for the heat exchanger 100. The two reservoirs S, tubes FR and fins WR contain a first metallic material, which is preferably an aluminum alloy. The tubes FR, two reservoirs S, and fins WR are joined to one another in a bonding process. The tubes FR, two reservoirs S, and fins WR exhibit a bonding agent for this. The tubes FR, two reservoirs S, and fins WR are preferably bonded together by brazing using a bonding agent containing a filler metal and a flux. The heat exchanger 100 contains two separate flow paths, which are not shown. The first flow path, through which the first medium flows, is in the two reservoirs S and the tubes FR (shown in part). The second medium M2 flows along the second flow path, surrounding the tubes FR. The diameter of two reservoirs S is greater than the width RB of the tubes FR. The inner surfaces of the two reservoirs S are subjected to the pressure of the first medium, expanding the two reservoirs S, subjecting them to tensile forces (shown in part). The ends of the tubes (FR) are therefore also subjected to pressure. Furthermore, the ends of the tubes FR are also subjected to pressure by the crimping. The reservoirs S are formed as integral pieces and can be produced in an extrusion process, or made of two parts that are bonded together. The tubes FR can be produced in an extrusion process and each contain numerous chambers (not shown). The tubes FR and fins WR form the block BL.

FIG. 2.1 shows a sectional view of the reservoir S cut along the first cutting plane 1, with an end FRE inserted into the partially shown slot SL, according to a first embodiment of the invention. The end FRE has a narrowing R on each narrow side. The two narrowings R are formed by stepped indentations between the end of the tube FR and the inner wall of the reservoir S. The end FRE has one step. This forms two collecting areas SB between the narrow sides FS of the ends FRE and the inner wall of the reservoir S. When assembling the heat exchanger, excess bonding agent advantageously collects in the two collecting areas SB and can harden there, at least reducing undesired ingress of the bonding agent into the tube FR (partially shown).

FIG. 2.2 shows a sectional view of the reservoir S cut along the first cutting plane 1, with an end FRE inserted into the partially shown slot SL, according to another embodiment of the invention. The end FRE has a narrowing R on each narrow side. The narrowings R are formed by stepped indentations between the end of the tube FR and the inner wall of the reservoir S. The end FRE has two steps. This advantageously forms two collecting areas SB between the narrow sides FS of the ends FRE and the inner wall of the reservoir S. When assembling the heat exchanger, excess bonding agent advantageously collects in the two collecting areas SB and can harden there, at least reducing undesired ingress of the bonding agent into the tube FR (partially shown).

FIG. 2.3 shows a sectional view of the reservoir S cut along the first cutting plane 1, with an end FRE inserted into the partially shown slot SL according to a first embodiment of the invention. The end FRE has a narrowing R on each narrow side. The two narrowings R are formed by a groove between the end of the tube FR and the inner wall of the reservoir S. The end FRE has two grooves formed by recesses. This forms two collecting areas SB between the narrow sides FS of the end FRE and the inner wall of the reservoir S. When assembling the heat exchanger, excess bonding agent advantageously collects in the two collecting areas SB and can harden there, at least reducing undesired ingress of the bonding agent into the tube FR (partially shown).

FIG. 2.4 shows a sectional view of an end FRE according to an exemplary embodiment of the invention cut along a plane that is parallel to the wide sides FB. This end FRE has a narrowing R on each narrow side. The two narrowings R are formed by stepped indentations, such that the end FRE has a step.

FIG. 2.5 shows a sectional view of an end FRE according to an exemplary embodiment of the invention cut along a plane that is parallel the wide sides FB. This end FRE has a narrowing R on each narrow side. The two narrowings R are formed by two stepped indentations, such that the end FRE has two steps.

FIG. 2.6 shows a sectional view of an end FRE according to an exemplary embodiment of the invention cut along a plane that is parallel the wide sides FB. This end FRE has a narrowing R on each narrow side. The two narrowings R are formed by grooves. The two grooves are formed by recesses.

FIG. 3.1 shows a sectional view of the reservoir S cut along the first cutting plane 1, with an end FRE inserted into the partially shown slot SL according to a first embodiment of the invention. The reservoir S has a widening SA. The slot SL is inside the widening SA. The widening SA is formed by a bulge in the wall of the reservoir S. The bulge, and therefore the widening SA, encircles the reservoir S. The bulge in the wall increases the cross section and therefore the diameter of the reservoir S. This increases the distance from the narrow side FS of the end to the wall of the reservoir S, advantageously forming two collecting areas SB between the narrow sides FS of the end FRE and the inner wall of the reservoir S. When assembling the heat exchanger, excess bonding agent advantageously collects in the two collecting areas SB and can harden there, at least reducing undesired ingress of the bonding agent into the tube FR (partially shown).

FIG. 3.2 shows a sectional view of the reservoir S cut along the first cutting plane 1, with an end FRE inserted into the partially shown slot SL according to a first embodiment of the invention. The reservoir S has a widening SA formed by a bulge in the slot on each of the short sides. The bulge in the slot SL increases the distance from the narrow side FS of the end FRE to the wall of the reservoir S, advantageously forming two collecting areas SB between the narrow sides FS of the end FRE and the inner wall of the reservoir S. When assembling the heat exchanger, excess bonding agent advantageously collects in the two collecting areas SB and can harden there, at least reducing undesired ingress of the bonding agent into the tube FR (partially shown).

FIG. 4 shows the first detail 1 of the reservoir S from above, according to an embodiment obtained with the invention. The end FRE is inserted in the slot SL. The reservoir S has an indentation adjacent to the widening SA. The slot SL is inside the widening SA. The indentation, and therefore the widening formed by the indentation, encircles the reservoir S. The widening enlarges the cross section and therefore the diameter of the reservoir S. This increases the distance from the narrow side FS of the end FRE to the wall of the reservoir S, advantageously forming two collecting areas SB between the narrow sides FS of the end FRE and the inner wall of the reservoir S. When assembling the heat exchanger, excess bonding agent advantageously collects in the two collecting areas SB and can harden there, at least reducing undesired ingress of the bonding agent into the tube FR (partially shown).

FIG. 5 shows a sectional view of the reservoir S cut along the first cutting plane 1, with an end FRE inserted into the partially shown slot SL according to one embodiment of the invention. The tube has numerous channels KA. The channels KA are spaced apart and separated from one another. These channels have a rectangular cross section. The reservoir S has widenings SA formed by grooves in the inner walls of the reservoirs at the level of the slots SL and connected thereto. The grooves increase the distance from the narrow sides FS of the end FRE to the wall of the reservoir S, advantageously forming two collecting areas SB between the narrow sides FS of the end FRE and the inner wall of the reservoir S. When assembling the heat exchanger, excess bonding agent advantageously collects in the two collecting areas SB and can harden there, at least reducing undesired ingress of the bonding agent into the tube FR (partially shown).

FIG. 6 shows the prior art. A sectional view of an existing reservoir S is shown in FIG. 6 with an end FRE inserted into the partially shown slot SL (prior art). The end FRE is partially inserted into the reservoir S. When assembling the heat exchanger, excess bonding agent unintentionally flows into the tube FR, because the distance between the narrow sides and the wall of the reservoir S is too small to prevent ingress of the bonding agent, or accommodate the bonding agent, such that the bonding agent hardens in the tube FR, thus clogging it (partially shown).

The specification can be readily understood with reference to the following Numbered Paragraphs:
Numbered Paragraph 1. A heat exchanger (100), preferably for a motor vehicle, that has:
   two media (M1, M2) that exchange heat,
   at least one reservoir (S) for the first medium (M1) containing numerous slots (SL), and
   numerous flat tubes (FR) connected to the reservoirs (S) through which the first medium (M1) flows and around which the second medium (M2) flows,
   wherein ends (FRE) of the tubes (FR) are inserted into the corresponding slots (SL),
characterized in that the ends (FRE) have external narrowings (R) on the narrow sides (FS), which are inside the reservoirs (S) and/or in that the reservoirs (S) have widening (SA) in their walls that are adjacent to the narrow sides (FS) of the ends (FRE) inside the reservoirs (S).
Numbered Paragraph 2. The heat exchanger (100) according to Numbered Paragraph 1, characterized in that the collecting areas (SB) are formed by narrowings (R) and/or widening (SA) after assembling the heat exchanger (100).
Numbered Paragraph 3. The heat exchanger (100) according to Numbered Paragraph 1 or 2, characterized in that the narrow sides (FS) of the tubes (FR) and the inner surface of the reservoirs (S) are spaced apart, at least partially.
Numbered Paragraph 4. The heat exchanger (100) according to Numbered Paragraph 1, 2, or 3, characterized in that the reservoirs (S) and tubes (FR) are bonded to one another, wherein the reservoirs (S) and/or tubes (FR) each have a bonding agent.
Numbered Paragraph 5. The heat exchanger (100) according to Numbered Paragraph 5, characterized in that the collecting areas (SB) are at least partially filled with bonding agent after assembling the heat exchanger (100).
Numbered Paragraph 6. The heat exchanger (100) according to Numbered Paragraph 1, 2, 3, 4, or 5, characterized in that the narrowings (R) are each formed by at least one stepped indentation in the end (FRE) of the tubes (FR) along the narrow sides (FS) thereof.
Numbered Paragraph 7. The heat exchanger (100) according to Numbered Paragraph 1, 2, 3, 4, or 5, characterized in that the narrowings (R) are each formed by a groove in the narrow sides (SE) of the ends (FRE) of the tubes (FR).
Numbered Paragraph 8. The heat exchanger (100) according to Numbered Paragraph 1, 2, 3, 4, or 5, characterized in that the widenings (SA) are each formed by grooves on the inner walls of the reservoirs (S), which are at the levels of the slots (SL) and connected thereto.
Numbered Paragraph 9. The heat exchanger (100) according to Numbered Paragraph 1, 2, 3, 4, or 5, characterized in that the widenings (SA) are each formed by bulges on the short sides of the slots (SL).
Numbered Paragraph 10. The heat exchanger (100) according to Numbered Paragraph 1, 2, 3, 4, or 5, characterized in that the widenings (SA) are formed by bulges in the walls of the reservoirs (S), wherein the slots (SL) are in the bulges.
Numbered Paragraph 11. The heat exchanger (100) according to Numbered Paragraph 1, 2, 3, 4, or 5, characterized in that the reservoirs (S) each have numerous indentations in their walls, such that the widenings (SA) are formed next to these indentations, wherein the slots (SL) are in the widenings (SA).
Numbered Paragraph 12. The heat exchanger (100) according to Numbered Paragraph 10 or 11, characterized in that the widenings (SA) are circumferential.
Numbered Paragraph 13. The heat exchanger (100) according to any of the Numbered Paragraphs 1 to 12, characterized in that the slots (SL) are substantially horizontal to the direction in which the reservoirs (S) extend, wherein the tubes (FR) are placed above one another along the length of the reservoirs (S).
Numbered Paragraph 14. The heat exchanger (100) according to any of the Numbered Paragraphs 1 to 12, characterized in that the tubes (FR) each have a main section (FRH), the width of which is substantially horizontal to the direction in which the reservoirs (S) extend, wherein the slots (SL) and ends (FRE) are rotated in relation to the main section (FRH), wherein the tubes (FR) are placed above one another along the length of the reservoirs (S).
Numbered Paragraph 15. A coolant circuit (200) or refrigerant circuit (201), preferably for a motor vehicle, that has a heat exchanger (100) according to any of the Numbered Paragraphs 1 to 14.

### LIST OF REFERENCE SYMBOLS

100 heat exchanger obtained with the invention
200 coolant circuit containing a heat exchanger obtained with the invention
201 refrigerant circuit containing a heat exchanger obtained with the invention
M1, M2 media
S reservoir
SL slot in a reservoir
FR flat tube
FRE end of a flat tube
FRH main part of a flat tube
FS narrow side of a flat tube
FB wide side of a flat tube
R narrowing of an end obtained with the invention
SA widening of a reservoir obtained with the invention
SB collecting area for liquid bonding agent obtained with the invention
WR corrugated fins
BL block formed by the flat tubes and corrugated fins
KA channels in the flat tubes

1-15. (canceled)

16. A heat exchanger, preferably for a motor vehicle, comprising:
two media that exchange heat,
at least one reservoir arranged to receive a first media the at least one reservoir comprising a plurality of slots, and
a plurality of flat tubes connected to the reservoirs through which the first media is configured to flow and around which a second media is configured to flow, the first and second media are configured to exchange heat with each other during flow,
wherein ends of the plurality of tubes are inserted into the corresponding slots,
wherein the ends have external narrowings on narrow sides thereof, which are inside the reservoirs and/or in that the reservoirs have widening in their walls that are adjacent to the narrow sides of the ends inside the reservoirs.

17. The heat exchanger according to claim 16, wherein collecting areas are established between narrowings and/or widenings in the walls and the reservoir of the assembled heat exchanger.

18. The heat exchanger according to claim 16, wherein the narrow sides of the tubes and the inner surface of the reservoirs are spaced apart to establish one or more collecting areas.

19. The heat exchanger according to claim 16, wherein the reservoirs and tubes are bonded to one another, wherein the reservoirs and the tubes each have a bonding agent.

20. The heat exchanger according to claim 16, wherein the collecting areas are at least partially filled with a bonding agent after assembling the heat exchanger.

21. The heat exchanger according to claim 16, wherein the narrowings are each formed by at least one stepped indentation in the end of the tubes along the narrow sides thereof.

22. The heat exchanger according to claim 16, wherein the narrowings are each formed by a groove in the narrow sides of the ends of the tubes.

23. The heat exchanger according to claim 16, wherein the widenings are each formed by grooves on the inner walls of the reservoirs, which are at the levels of the slots and connected thereto.

24. The heat exchanger according to claim 16, wherein the widenings are each formed by bulges on short sides of the slots.

25. The heat exchanger according to claim 16, wherein the widenings upon the reservoir are formed by bulges in the walls of the reservoirs, wherein the slots are in the bulges.

26. The heat exchanger according to claim 16, wherein the reservoirs each have a plurality of indentations in their walls, such that the widenings upon the reservoir are formed next to the respective plurality of indentations, wherein the slots are in the widenings.

27. The heat exchanger according to claim 25, wherein the widenings are circumferential.

28. The heat exchanger according to claim 16, wherein the slots are substantially horizontal to the direction in which the reservoir extends, wherein the tubes are placed above one another along the length of the reservoir.

29. The heat exchanger according to claim 16, wherein the tubes each have a main section, the width of which is substantially horizontal to the direction in which the reservoir extends, wherein the slots and ends are rotated in relation to the main section, wherein the tubes are placed above one another along the length of the reservoir.

30. A coolant circuit or refrigerant circuit, for a motor vehicle, that has a heat exchanger according to claim 16.
